(19) United States
(12) Patent Application Publication
(10) Pub. No.: US 2022/0405402 A1
(43) Pub. Date: Dec. 22, 2022

(54) SYSTEM AND METHOD FOR A GLOBAL PATENT REGISTRY

(71) Applicant: ERICH LAWSON SPANGENBERG, Paris (FR)

(72) Inventor: ERICH LAWSON SPANGENBERG, Paris (FR)

(21) Appl. No.: 17/693,269

(22) Filed: Mar. 11, 2022

Related U.S. Application Data
(60) Provisional application No. 63/161,179, filed on Mar. 15, 2021.

(51) Int. Cl. G06F 21/60; H04L 9/00; G06Q 50/18

(52) U.S. Cl. CPC G06F 21/602; H04L 9/50; G06Q 50/184

(57) ABSTRACT

The present invention is a user-friendly patent ecosystem incorporating an analytics engine and Hyperledger. The present invention manages its blockchain-based Global Patent Registry (GPR) on Hyperledger. The present invention provides a GPR blockchain solution for chain of custody patent registration with a focus on backward-compatibility for the IP platform middleware of the present invention.

### PRIORITY CLAIMS

This application claims the benefit of U.S. Provisional Application Ser. No. 63/161,179 filed on Mar. 15, 2021, the contents of which are incorporated herein.

### BACKGROUND OF THE INVENTION

The field of invention is related to patent registration.

### SUMMARY OF THE INVENTION

The present invention is a chain of custody (CoC) solution for public patent data records using blockchain wherein all information moving to the public blockchain is encrypted by default. The encrypted information uses a key generated by a certificate manager, and the user initiating the transfer of the information to the public blockchain is able to identify parts of the information that could be selectively decided to be kept accessible to the public, such as ownership information for a patent asset.

The present invention uses public blockchain to store, secure, and trace patent data. The result is a paradigm shift in the application and role of patents in finance, technology, and enterprise. Intellectual Property (IP) is the largest and often most critical asset on most corporate balance sheets. Corporations are taking a greater interest in how IP is tracked, managed and deployed. A first step in the evolution of an improved understanding and management of this critical asset is a reliable CoC solution.

The present invention provides secure, cryptographic access to critical data about patents. The CoC solution enables the primary data to remain on a Hyperledger with selective, high-value information migrated and maintained on the public blockchain, enabling that patent data to be encrypted (all data is encrypted by default, but authors can choose to exclude certain fields from encryption so that it is open for public view), with decryption available only to the parties holding the encryption keys. In the case of patents, those parties are likely to be the patent holders themselves, any entities licensed to use the patent, and selective regulatory agencies if necessary.

The present invention also implements an integration infrastructure to create a Global Patent Registry (GPR) with the blockchain to support a consortium of Patent Owners, National Patent Offices, and Verifiers. GPR allows for the current process of granting, publishing, owning, transferring, and pledging patents onto the blockchain of the present invention, using smart contracts to manage these processes. GPR enables strong provenance capabilities, allowing for patents to be clearly traced as they are created, maintained, licensed, and transferred. The result is a more efficient, complete, equitable, globally compliant, and revenue-generating patent ecosystem that supports patent owners, licensers, granting authorities, and verifiers.

The present invention demonstrates the ability for the blockchain to work with Hyperledger, whereby transactions are initiated on Hyperledger. A trigger could be specified by the present invention to initiate transfer of data to the public blockchain. All the information moving to public blockchain is encrypted by default. Encrypted information uses a key generated by a Certificate Manager, which is what is implemented in the present invention's current design on Hyperledger. The user initiating the transfer of the information to the public blockchain is able to identify parts of the information that could be selectively decided to be kept accessible to the public for example ownership of the patent. The present invention has created a proof of concept and that demonstrates the above capability including a frontend application. The present invention can also be used on other blockchains and is not limited to Hyperledger.

in another embodiment, the present invention is able to implement the PoC using Delta Testnet. The present invention is able to engage with the IBM team to understand their requirements for supporting Global Repository of Patents (GRP) for potential public consortium involving the present invention for private deals and design a public/private hybrid architecture for the same. The present invention can identify parts of the current logic and implementation that can be written as smart contracts on the blockchain in order to create a PoC smart contract.

Intellectual property is a vast umbrella of complex, intangible assets. IP is crucial to protect and uphold, but also difficult to do so by virtue of it being intangible. Verification of the most basic information such as origin, existence, ownership and chain of title are not reliable nor readily available. A solution to increase transparency and ease of establishing and evaluating these most fundamental facts about IP—including Title, Provenance, and Transactional Efficiency—is needed to increase value capture and utilization of the IP asset class.

Owners of IP and their transaction partners need to remain confident that title is properly recorded and known. Core to this goal is the assurance that access to IP can be granted, reviewed, and revoked by its primary owner or guardian at any time. More difficult is the reality that only portions of one's IP may be best suited for public exposure, with the most sensitive elements needing to be restricted. The complexity in permissions is simply not practically supported by existing technology. Blockchain technology can ensure that IP records are not manipulated nor deleted, while providing the flexibility for certain permitted parties to have selective access of on-chain data.

Intellectual property can change hands frequently and for many different reasons. IP can be voluntarily transferred to other individuals or entities through an agreement, temporarily or indefinitely licensed to outside parties, forcibly transferred to another party due to legal action, or dissolved as a piece of defined IP due to legal review. Encumbrances are created as a result of lending transactions and other corporate transactions. At its worst, these transfers and actions create a complex, disparate, and unorganized record of provenance that is difficult to store, frustrating to maintain, and operationally expensive to review, verify, and update. Blockchain technology's public and transparent nature ensures everyone can see the record of data entries. Decentralization ensures there is no central source of manipulation, so provenance on a blockchain network can be verified and assured by any individual.

Intellectual property can be difficult to monetize, particularly because of the difficulty of identifying the chain of ownership and provenance noted above, but also because of the costs these inefficiencies create. For patents in particular, patent owners lose out on an estimated $1 Trillion of potential revenue in the US alone each year in missed partnerships. A transparent and reliable means to verify these attributes are the first required step in improving management and returns on this critical asset.

The blockchain of the present invention is uniquely tailored to solving the types of problems currently faced by the intellectual property ecosystem, especially with regards to patent management.

The present invention enables network users to selectively grant and revoke permission to some or all data stored on the blockchain. IP owners can ensure that only specific parties have access to certain data and can revoke some or all of that access in more efficient ways than currently available. Access may be revoked manually due to an agreement or breach of contract or may be programmed via a smart contract to terminate automatically with the terms of a subscription.

The present invention establishes a clear chain of records through cryptographic hashes that are stored on the network. For private networks, secure and private records can be compiled and “sent” to the public blockchain, ensuring the data can be irrefutably verified but no information is revealed.

With robust support of data provenance and the ability to encode payments through smart contracts, the present invention enables these systems to confidently ensure payments are distributed fairly to patent and IP beneficiaries while reducing the associated cost and difficulty.

In another embodiment, the present invention uses a Global Patent Registry, whereby an issuing enterprise such as a patent office has recorded that a patent asset has been granted to a certain company. Then that company which owns that particular patent is registered on the block chain. In the case of a sale of the patent, the ownership is transferred to the new owner and anybody can go to that chain and see the existence of the asset and who owns it and potentially, other details, such as post issuance events like records of litigation, pledges or standards etc.

In another embodiment, the present invention uses Smart legal contracts. This would be private between two organizations and covers use cases like licensing of a patent asset. The smart legal contract for the license would cover initial payments, quarterly payment of commission based on sales, proof certificate of incorporation, etc. There would be definition of events and pre-conditions for those to happen as well as effects of those conditions, that would need to be managed through the blockchain.

In another embodiment, the present invention uses provenance for ideas, whereby a contract with the ability to timestamp an inventive idea which is encrypted in such a way that one could establish its existence, but not its contents. This can eventually be attached to a patent application and have it live with the life of the patent, even through sale of the patent. As a part of a patent sale, the buyer would get the record of existence of when that invention started, and would know who the inventor is etc. Alternatively, one could potentially transact the know-how of that inventive idea, even if there wasn't a patent associated with it. This is significant because it establishes some provenance and the present invention can incorporate an existing customer base.

The present invention operates a permission-based network with the ability to create user accounts and certificates. Interactions with Hyperledger are through an integration manager.

The present invention is a user-friendly patent ecosystem incorporating an analytics engine and Hyperledger. The present invention manages its blockchain-based Global Patent Registry (GPR) on Hyperledger. The present invention provides a GPR blockchain solution for chain of custody patent registration with a focus on backward-compatibility for the IP platform middleware of the present invention.

The IP registration lifecycle starts with a patent applicant or inventor applies to a patent using regular means trough the State Patent Office. The State Office assigns the patent a status. The applicant or inventor can add patent reference, application and grant number. The backend of the IP platform of the present invention mirrors the patent metadata and contents into a decentralized storage, optionally in encrypted form. The Interplanetary File System (IPFS), which is a protocol and peer-to-peer network for storing and sharing data in a distributed file system, uses “pinned hash” data which is stored in the blockchain patent registry IP platform of the present invention. The platform makes this Deploy hash available to Patent Owner, and can also make provide it to the state office.

In the IP amendment lifecycle, the GPR updates the status or the contents and pledges of the patent, and can also provide updates to the state office. The patent gets a new on-chain hash. The backend of the IP platform of the present invention updates all related foreign keys for the patent on connect organizations to this new hash. The IP platform maintains a relational database for information on IP licensors and pledges, as this data is either made partially available or not available at all on the state office end.

In the IP licensing lifecycle, a licensor initiates a license application trough the IP platform of the present invention. The platform then creates a new organization, wherein multiple legal entities can be present. The IP platform of the present invention internally assigns the patent reference to one of the legal entities under the previously made organization, and can also transmit this information to the state office.

In another embodiment, the present invention can also include privacy features such as private membership proofs with accumulators. If a company holds a license to a patent, this can be verified on-chain only, without making the patent contents (besides identification data) visible, or the licensors of this patents. This can be done with private set-membership proofs in constant size and time using hash accumulators which is currently not supported on Hyperledger

### BRIEF DESCRIPTION OF THE DRAWINGS

FIG. 1 is a sequence diagram of the current architecture of the present invention.

FIG. 2 is an illustration depicting an exemplary operating environment including one or more user computers, computing devices, or processing devices, which can be used to operate a client, such as a dedicated application, web browser is shown.

FIG. 3 is another illustration depicting an exemplary operating environment including a computer system with various elements as shown.

FIG. 4 is a line diagram illustrating a decentralized network.

FIG. 5 is a line diagram illustrating a distributed network.

FIG. 6 is a process overview of the present invention.

FIG. 7 is a detailed sequence diagram of the current architecture of the present invention.

### DETAILED DESCRIPTION OF THE PREFERRED EMBODIMENT

The present invention is a chain of custody (CoC) solution for public patent data records using blockchain wherein all information moving to the public blockchain is encrypted by default. The encrypted information uses a key generated by a certificate manager, and the user initiating the transfer of the information to the public blockchain is able to identify parts of the information that could be selectively decided to be kept accessible to the public, such as ownership information for a patent asset.

The present invention uses public blockchain to store, secure, and trace patent data. The result is a paradigm shift in the application and role of patents in finance, technology, and enterprise. Intellectual Property (IP) is the largest and often most critical asset on most corporate balance sheets. Corporations are taking a greater interest in how IP is tracked, managed and deployed. A first step in the evolution of an improved understanding and management of this critical asset is a reliable CoC solution.

The present invention provides secure, cryptographic access to critical data about patents. The CoC solution enables the primary data to remain on a Hyperledger with selective, high-value information migrated and maintained on the public blockchain, enabling that patent data to be encrypted (all data is encrypted by default, but authors can choose to exclude certain fields from encryption so that it is open for public view), with decryption available only to the parties holding the encryption keys. In the case of patents, those parties are likely to be the patent holders themselves, any entities licensed to use the patent, and selective regulatory agencies if necessary.

The present invention also implements an integration infrastructure to create a Global Patent Registry (GPR) with the blockchain to support a consortium of Patent Owners, National Patent Offices, and Verifiers. GPR allows for the current process of granting, publishing, owning, transferring, and pledging patents onto the blockchain of the present invention, using smart contracts to manage these processes. GPR enables strong provenance capabilities, allowing for patents to be clearly traced as they are created, maintained, licensed, and transferred. The result is a more efficient, complete, equitable, globally compliant, and revenue-generating patent ecosystem that supports patent owners, licensers, granting authorities, and verifiers.

The present invention is a user-friendly patent ecosystem incorporating an analytics engine and Hyperledger. The present invention manages its blockchain-based Global Patent Registry (GPR) on Hyperledger. The present invention provides a GPR blockchain solution for chain of custody patent registration with a focus on backward-compatibility for the IP platform middleware of the present invention.

The IP registration lifecycle starts with a patent applicant or inventor applies to a patent using regular means trough the State Patent Office. The State Office assigns the patent a status. The applicant or inventor can add patent reference, application and grant number. The backend of the IP platform of the present invention mirrors the patent metadata and contents into a decentralized storage, optionally in encrypted form. The Interplanetary File System (IPFS), which is a protocol and peer-to-peer network for storing and sharing data in a distributed file system, uses “pinned hash” data which is stored in the blockchain patent registry IP platform of the present invention. The platform makes this Deploy hash available to Patent Owner, and can also make provide it to the state office.

In the IP amendment lifecycle, the GPR updates the status or the contents and pledges of the patent, and can also provide updates to the state office. The patent gets a new on-chain hash. The backend of the IP platform of the present invention updates all related foreign keys for the patent on connect organizations to this new hash. The IP platform maintains a relational database for information on IP licensors and pledges, as this data is either made partially available or not available at all on the state office end.

In the IP licensing lifecycle, a licensor initiates a license application trough the IP platform of the present invention. The platform then creates a new organization, wherein multiple legal entities can be present. The IP platform of the present invention internally assigns the patent reference to one of the legal entities under the previously made organization, and can also transmit this information to the state office.

In another embodiment, the present invention can also include privacy features such as private membership proofs with accumulators. If a company holds a license to a patent, this can be verified on-chain only, without making the patent contents (besides identification data) visible, or the licensors of this patents. This can be done with private set-membership proofs in constant size and time using hash accumulators which is currently not supported on Hyperledger

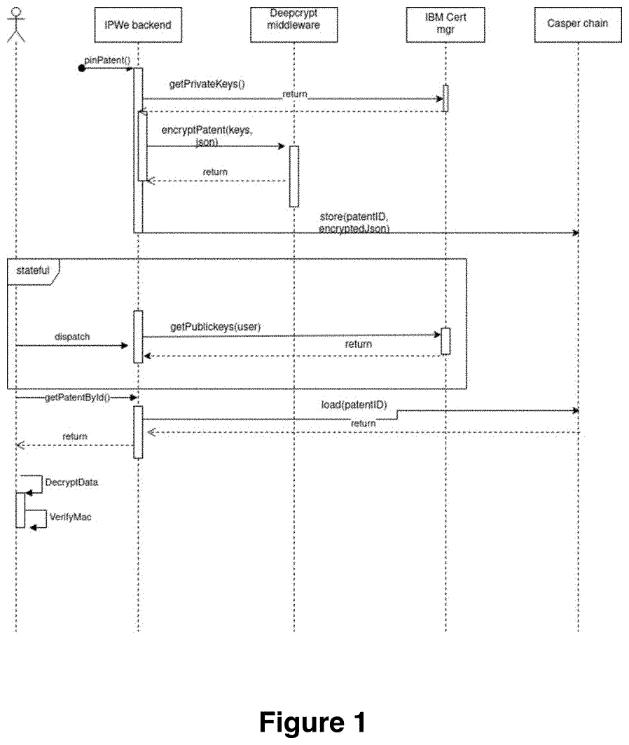

FIG. 1 is a sequence diagram of the current architecture of the present invention. In accordance with the preferred embodiment of the present invention, transactions initiated on Hyperledger. A data transfer is then triggered to the public blockchain. This data is encrypted via a certificate manager, and the encryption scope and depth is user defined. The key value stores smart contracts on the blockchain.

The present invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents.

Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

The units described above can be implemented as software components executing on one or more general purpose processors, as hardware such as programmable logic devices and/or Application Specific Integrated Circuits designed to perform certain functions or a combination thereof. In some embodiments, the units can be embodied by a form of software products which can be stored in a nonvolatile storage medium (such as optical disk, flash storage device, mobile hard disk, etc.), including a number of instructions for making a computer device (such as personal computers, servers, network equipment, etc.) implement the methods described in the embodiments of the present invention. The units may be implemented on a single device or distributed across multiple devices. The functions of the units may be merged into one another or further split into multiple sub-units.

The methods or algorithmic steps described in light of the embodiments disclosed herein can be implemented using hardware, processor-executed software modules, or combinations of both. Software modules can be installed in random-access memory (RAM), memory, read-only memory (ROM), electrically programmable ROM, electrically erasable programmable ROM, registers, hard drives, removable disks, CD-ROM, or any other forms of storage media known in the technical field.

Persons of ordinary skill in the art are able to understand that all or portions of the steps in the embodiments described above may be realized using programs instructing the relevant hardware, and said programs can be stored on computer-readable storage media, such as a read-only memory, hard disk or compact disc. Optionally, all or portions of the steps of the embodiments described above may also be realized using one or multiple integrated circuits. Accordingly, the various modules/units contained in the embodiments above may also be realized in the form of hardware or software function modules. Thus, the present application is not limited to any specific combination of hardware and software.

The present application may have a variety of other embodiments and, without departing from the spirit and substance of the present application, persons skilled in the art may produce a variety of corresponding changes and modifications based on the present application, but these corresponding changes and modifications shall all fall within the scope of protection of the claims of this application.

Although the foregoing embodiments have been described in some detail for purposes of clarity of understanding, the invention is not limited to the details provided. There are many alternative ways of implementing the invention. The disclosed embodiments are illustrative and not restrictive.

While the invention has been described in detail and with reference to specific embodiments thereof, it will be apparent to those skilled in the art that various changes and modifications can be made therein without departing from the spirit and scope thereof. Thus, it is intended that the present invention cover the modifications and variations of this invention provided they come within the scope of the appended claims and their equivalents.

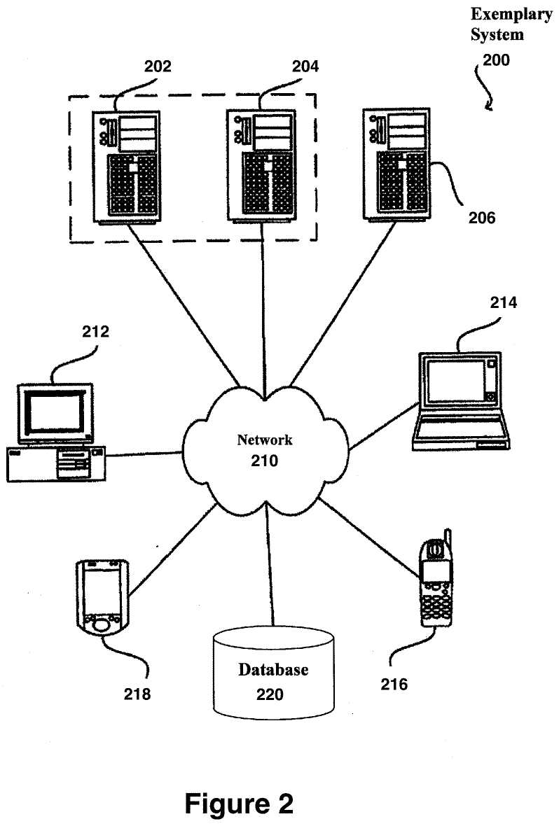

FIG. 2 is a block diagram illustrating components of an exemplary operating environment in which embodiments of the present invention may be implemented. The system 200 can include one or more user computers, computing devices, or processing devices 212, 214, 216, 218, which can be used to operate a client, such as a dedicated application, web browser, etc. The user computers 212, 214, 216, 218 can be general purpose personal computers (including, merely by way of example, personal computers and/or laptop computers running a standard operating system), cell phones or PDAs (running mobile software and being Internet, e-mail, SMS, Blackberry, or other communication protocol enabled), and/or workstation computers running any of a variety of commercially-available UNIX or UNIX-like operating systems (including without limitation, the variety of GNU/Linux operating systems). These user computers 212, 214, 216, 218 may also have any of a variety of applications, including one or more development systems, database client and/or server applications, and Web browser applications. Alternatively, the user computers 212, 214, 216, 218 may be any other electronic device, such as a thin-client computer, Internet-enabled gaming system, and/or personal messaging device, capable of communicating via a network (e.g., the network 210 described below) and/or displaying and navigating Web pages or other types of electronic documents. Although the exemplary system 200 is shown with four user computers, any number of user computers may be supported.

In most embodiments, the system 200 includes some type of network 210. The network can be any type of network familiar to those skilled in the art that can support data communications using any of a variety of commercially available protocols, including without limitation TCP/IP, SNA, IPX, AppleTalk, and the like. Merely by way of example, the network 210 can be a local area network (“LAN”), such as an Ethernet network, a Token-Ring network and/or the like; a wide-area network; a virtual network, including without limitation a virtual private network (“VPN”); the Internet; an intranet; an extranet; a public switched telephone network (“PSTN”); an infra-red network; a wireless network (e.g., a network operating under any of the IEEE 802.11 suite of protocols, GRPS, GSM, UMTS, EDGE, 2G, 2.5G, 3G, 4G, Wimax, WiFi, CDMA 2000, WCDMA, the Bluetooth protocol known in the art, and/or any other wireless protocol); and/or any combination of these and/or other networks.

The system may also include one or more server computers 202, 204, 206 which can be general purpose computers, specialized server computers (including, merely by way of example, PC servers, UNIX servers, mid-range servers, mainframe computers rack-mounted servers, etc.), server farms, server clusters, or any other appropriate arrangement and/or combination. One or more of the servers (e.g., 206) may be dedicated to running applications, such as a business application, a Web server, application server, etc. Such servers may be used to process requests from user computers 212, 214, 216, 218. The applications can also include any number of applications for controlling access to resources of the servers 202, 204, 206.

The Web server can be running an operating system including any of those discussed above, as well as any commercially available server operating systems. The Web server can also run any of a variety of server applications and/or mid-tier applications, including HTTP servers, FTP servers, CGI servers, database servers, Java servers, business applications, and the like. The server(s) also may be one or more computers which can be capable of executing programs or scripts in response to the user computers 212, 214, 216, 218. As one example, a server may execute one or more Web applications. The Web application may be implemented as one or more scripts or programs written in any programming language, such as Java®, C, C # or C++, and/or any scripting language, such as Perl, Python, or TCL, as well as combinations of any programming/scripting languages. The server(s) may also include database servers, including without limitation those commercially available from Oracle®, Microsoft®, Sybase®, IBM® and the like, which can process requests from database clients running on a user computer 212, 214, 216, 218.

The system 200 may also include one or more databases 220. The database(s) 220 may reside in a variety of locations. By way of example, a database 620 may reside on a storage medium local to (and/or resident in) one or more of the computers 202, 204, 206, 212, 214, 216, 218. Alternatively, it may be remote from any or all of

the computers 202, 204, 206, 212, 214, 216, 218, and/or in communication (e.g., via the network 210) with one or more of these. In a particular set of embodiments, the database 220 may reside in a storage-area network (“SAN”) familiar to those skilled in the art. Similarly, any necessary files for performing the functions attributed to the computers 202, 204, 206, 212, 214, 216, 218 may be stored locally on the respective computer and/or remotely, as appropriate. In one set of embodiments, the database 220 may be a relational database, such as Oracle 10g, that is adapted to store, update, and retrieve data in response to SQL-formatted commands.

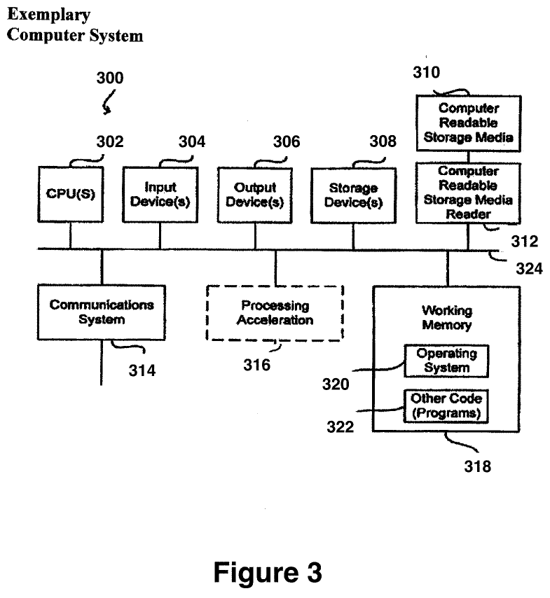

FIG. 3 illustrates an exemplary computer system 300, in which embodiments of the present invention may be implemented. The system 300 may be used to implement any of the computer systems described above. The computer system 300 is shown comprising hardware elements that may be electrically coupled via a bus 324. The hardware elements may include one or more central processing units (CPUs) 302, one or more input devices 304 (e.g., a mouse, a keyboard, etc.), and one or more output devices 306 (e.g., a display device, a printer, etc.). The computer system 300 may also include one or more storage devices 308. By way of example, the storage device(s) 308 can include devices such as disk drives, optical storage devices, solid-state storage device such as a random access memory (“RAM”) and/or a read-only memory (“ROM”), which can be programmable, flash-updateable and/or the like.

The computer system 300 may additionally include a computer-readable storage media reader 312, a communications system 314 (e.g., a modem, a network card (wireless or wired), an infra-red communication device, etc.), and working memory 318, which may include RAM and ROM devices as described above. In some embodiments, the computer system 300 may also include a processing acceleration unit 316, which can include a digital signal processor DSP, a special-purpose processor, and/or the like.

The computer-readable storage media reader 312 can further be connected to a computer-readable storage medium 310, together (and, optionally, in combination with storage device(s) 308) comprehensively representing remote, local, fixed, and/or removable storage devices plus storage media for temporarily and/or more permanently containing, storing, transmitting, and retrieving computer-readable information. The communications system 314 may permit data to be exchanged with the network and/or any other computer described above with respect to the system 300.

The computer system 300 may also comprise software elements, shown as being currently located within a working memory 318, including an operating system 320 and/or other code 322, such as an application program (which may be a client application, Web browser, mid-tier application, RDBMS, etc.). It should be appreciated that alternate embodiments of a computer system 300 may have numerous variations from that described above. For example, customized hardware might also be used and/or particular elements might be implemented in hardware, software (including portable software, such as applets), or both. Further, connection to other computing devices such as network input/output devices may be employed.

Storage media and computer readable media for containing code, or portions of code, can include any appropriate media known or used in the art, including storage media and communication media, such as but not limited to volatile and non-volatile, removable and non-removable media implemented in any method or technology for storage and/or transmission of information such as computer readable instructions, data structures, program modules, or other data, including RAM, ROM, EEPROM, flash memory or other memory technology, CD-ROM, digital versatile disk (DVD) or other optical storage, magnetic cassettes, magnetic tape, magnetic disk storage or other magnetic storage devices, data signals, data transmissions, or any other medium which can be used to store or transmit the desired information and which can be accessed by the computer. Based on the disclosure and teachings provided herein, a person of ordinary skill in the art will appreciate other ways and/or methods to implement the various embodiments.

As discussed above, embodiments are suitable for use with the Internet, which refers to a specific global internetwork of networks. However, it should be understood that other networks can be used instead of the Internet, such as an intranet, an extranet, a virtual private network (VPN), a non-TCP/IP based network, any LAN or WAN or the like.

FIG. 3 further illustrates an environment where an on-demand distributed database service might be used. As illustrated in FIG. 3 user systems might interact via a network with an on-demand database. Some on-demand databases may store information from one or more records stored into tables of one or more distributed database images to form a database management system (DBMS). Accordingly, on-demand database and system will be used interchangeably herein. A database image may include one or more database objects. A relational database management system (RDMS) or the equivalent may execute storage and retrieval of information against the database object(s). Some on-demand database services may include an application platform that enables creation, managing and executing one or more applications developed by the provider of the on-demand database service, wherein users accesses the on-demand database service via user systems, or third party application developers access the on-demand database service via user systems.

The security of a particular user system might be entirely determined by permissions (permission levels) for the current user. For example, where a user account identification transaction may involve a portable identification alpha-numeric data field physically or digitally linked to a personal primary identification device to request services from a provider account and wherein the user is using a particular user system to interact with System, that user system has the permissions allotted to that user account. However, while an administrator is using that user system to interact with System, that user system has the permissions allotted to that administrator. In systems with a hierarchical role model, users at one permission level may have access to applications, data, and database information accessible by a lower permission level user, but may not have access to certain applications, database information, and data accessible by a user at a higher permission level. Thus, different users will have different permissions with regard to accessing and modifying application and database information, depending on a user's security or permission level.

A network can be a LAN (local area network), WAN (wide area network), wireless network, point-to-point network, star network, token ring network, hub network, or other appropriate configuration. As the most common type of network in current use is a TCP/IP (Transfer Control Protocol and Internet Protocol) network such as the global internetwork of networks often referred to as the “Internet” with a capital “I,” that will be used in many of the examples herein. However, it should be understood that the networks that the present invention might use are not so limited, although TCP/IP is a frequently implemented protocol.

User systems might communicate with a system using TCP/IP and, at a higher network level, use other common Internet protocols to communicate, such as HTTP, FTP, AFS, WAP, etc. In an example where HTTP is used, a user system might include an HTTP client commonly referred to as a “browser” for sending and receiving HTTP messages to and from an HTTP server at System. Such HTTP server might be implemented as the sole network interface between a system and network, but other techniques might be used as well or instead. In some implementations, the interface between a system and network includes load sharing functionality, such as round-robin HTTP request distributors to balance loads and distribute incoming HTTP requests evenly over a plurality of servers. At least as for the users that are accessing that server, each of the plurality of servers has access to at least one third party entity system data schema; however, other alternative configurations are contemplated.

According to one arrangement, each user system and all of its components are operator configurable using applications, such as a browser, including computer code run using a central processing unit such as an Intel Pentium® processor or the like. Similarly, a computer system (and additional instances of an enterprise database, where more than one is present) and all of their components might be operator configurable using application(s) including computer code run using a central processing unit such as an Intel Pentium® processor or the like, or multiple processor units. A computer program product aspect includes a machine-readable storage medium (media) having instructions stored thereon/in which can be used to program a computer to perform any of the processes of the embodiments described herein. Computer code for operating and configuring systems to intercommunicate and to process web pages, applications and other data and media content as described herein is preferably downloaded and stored on a hard disk, but the entire program code, or portions thereof, may also be locally stored in any other volatile or non-volatile memory medium or device as is well known, such as a ROM or RAM, or provided on any media capable of storing program code, such as any type of rotating media including floppy disks, optical discs, digital versatile disk (DVD), compact disk (CD), Microdrive, and magneto-optical disks, and magnetic or optical cards, nanosystems (including molecular memory ICs), or any type of media or device suitable for storing instructions and/or data. Additionally, the entire program code, or portions thereof, may be transmitted and downloaded from a software source over a transmission medium, e.g., over the Internet, or from another server, as is well known, or transmitted over any other conventional network connection as is well known (e.g., extranet, VPN, LAN, etc.) using any communication medium and protocols (e.g., TCP/IP, HTTP, HTTPS, Ethernet, etc.) as are well known. It will also be appreciated that computer code for implementing aspects of the present invention can be implemented in any programming language that can be executed on a client system and/or server or server system such as, for example, in C, C++, HTML, any other markup language, Java®, JavaScript, ActiveX, any other scripting language such as VBScript, and many other programming languages as are well known. (Java® is a trademark of Sun Microsystems, Inc.).

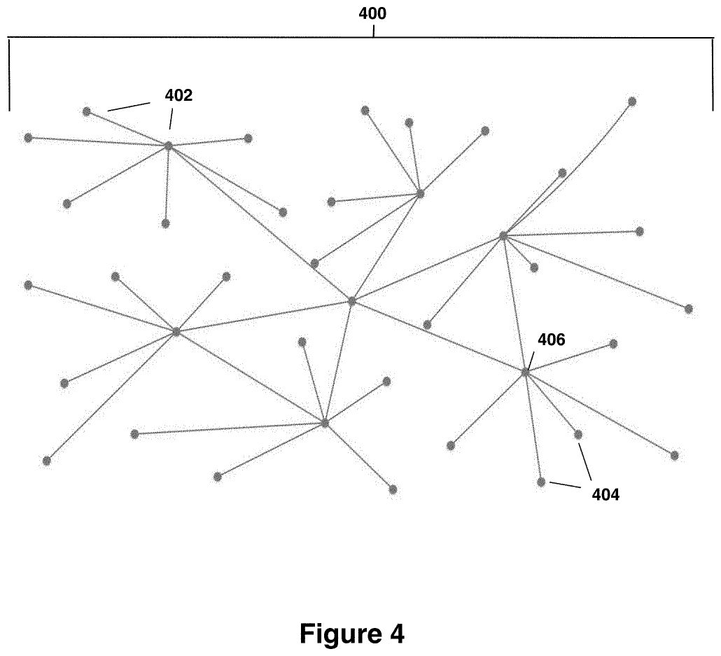

FIG. 4 is a line diagram illustrating a decentralized network. In accordance with the preferred embodiment of the present invention, the specific architecture of the network can be either decentralized or distributed. FIG. 4, generally represented by the numeral 400, provides an illustrative diagram of the decentralized network. FIG. 4 depicts each node with a dot 402 Under this system, each node is connected to at least one other node 404. Only some nodes are connected to more than one node 406.

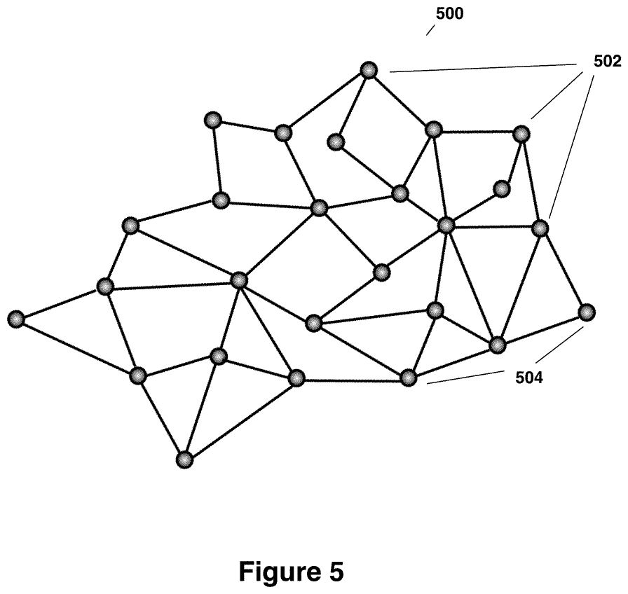

FIG. 5 is a line diagram illustrating a distributed network. For comparison purposes, FIG. 5, which is generally represented by the numeral 500, illustrates a distributed network. Specifically, the illustration shows the interconnection of each node 502 in a distributed decentralized network 500. In accordance with the preferred embodiment of the present invention, each node 502 in the distributed network 500 is directly connected to at least two other nodes 504. This allows each node 502 to transact with at least one other node 502 in the network. The present invention can be deployed on a centralized, decentralized, or distributed network.

In one embodiment, each transaction (or a block of transactions) is incorporated, confirmed, verified, included, or otherwise validated into the blockchain via a consensus protocol. Consensus is a dynamic method of reaching agreement regarding any transaction that occurs in a decentralized system. In one embodiment, a distributed hierarchical registry is provided for device discovery and communication. The distributed hierarchical registry comprises a plurality of registry groups at a first level of the hierarchical registry, each registry group comprising a plurality of registry servers. The plurality of registry servers in a registry group provide services comprising receiving client update information from client devices, and responding to client lookup requests from client devices. The plurality of registry servers in each of the plurality of registry groups provide the services using, at least in part, a quorum consensus protocol.

As another example, a method is provided for device discovery and communication using a distributed hierarchical registry. The method comprises Broadcasting a request to identify a registry server, receiving a response from a registry server, and sending client update information to the registry server. The registry server is part of a registry group of the distributed hierarchical registry, and the registry group comprises a plurality of registry servers. The registry server updates other registry servers of the registry group with the client update information using, at least in part, a quorum consensus protocol. The present invention can also be used on other blockchains and is not limited to Hyperledger.

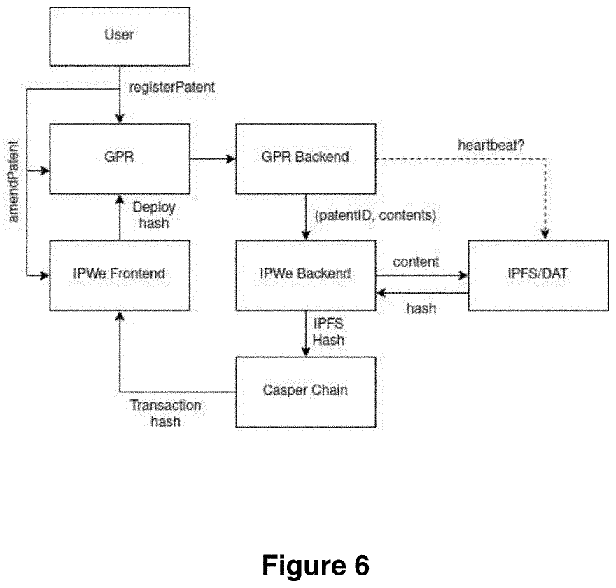

FIG. 6 is a process overview of the present invention. In accordance with the preferred embodiment, the patent applicant or inventor (platform user) can register and amend a patent on the GPR. The IP platform frontend can deploy hash to the GPR. The GPR backend transmits patent ID and patent contents data with the IP platform backend. The IP platform backend transmits content data to IPFS/DAT. The IPFS/DAT then transmits this content data hash back to the IP platform backend. The IP platform backend transmits the IPFS hash to the blockchain registry, and the registry transmits this transaction hash to the IP platform frontend.

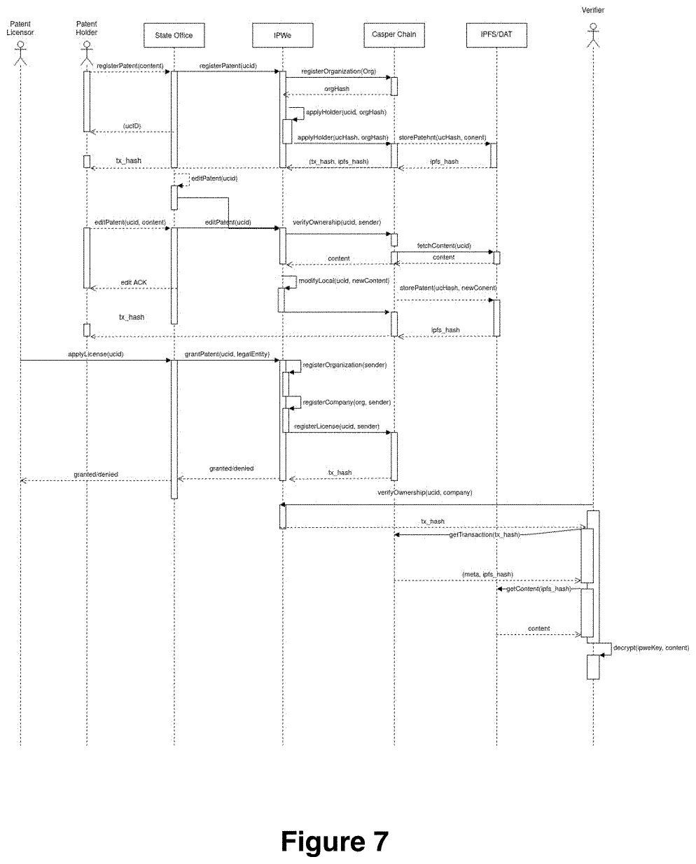

FIG. 7 is a detailed sequence diagram of the current architecture of the present invention. In accordance with the preferred embodiment, the architecture of the present invention can include: patent applicants or inventors; patent licensors; state patent offices; the IP platform of the present invention; the CoC blockchain patent registry of the present invention; and IPFS or DAT peer to peer hypermedia protocol.

While various embodiments of the disclosed technology have been described above, it should be understood that they have been presented by way of example only, and not of limitation. Likewise, the various diagrams may depict an example architectural or other configuration for the disclosed technology, which is done to aid in understanding the features and functionality that may be included in the disclosed technology. The disclosed technology is not restricted to the illustrated example architectures or configurations, but the desired features may be implemented using a variety of alternative architectures and configurations. Indeed, it will be apparent to one of skill in the art how alternative functional, logical or physical partitioning and configurations may be implemented to implement the desired features of the technology disclosed herein. Also, a multitude of different constituent module names other than those depicted herein may be applied to the various partitions. Additionally, with regard to flow diagrams, operational descriptions and method claims, the order in which the steps are presented herein shall not mandate that various embodiments be implemented to perform the recited functionality in the same order unless the context dictates otherwise.

Although the disclosed technology is described above in terms of various exemplary embodiments and implementations, it should be understood that the various features, aspects and functionality described in one or more of the individual embodiments are not limited in their applicability to the particular embodiment with which they are described, but instead may be applied, alone or in various combinations, to one or more of the other embodiments of the disclosed technology, whether or not such embodiments are described and whether or not such features are presented as being a part of a described embodiment. Thus, the breadth and scope of the technology disclosed herein should not be limited by any of the above-described exemplary embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, may be combined in a single package or separately maintained and can further be distributed in multiple groupings or packages or across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives may be implemented without confinement to the illustrated examples. For example, block diagrams and their accompanying description should not be construed as mandating a particular architecture or configuration.

While the present invention has been described with reference to one or more preferred embodiments, which embodiments have been set forth in considerable detail for the purposes of making a complete disclosure of the invention, such embodiments are merely exemplary and are not intended to be limiting or represent an exhaustive enumeration of all aspects of the invention. The scope of the invention, therefore, shall be defined solely by the following claims. Further, it will be apparent to those of skill in the art that numerous changes may be made in such details without departing from the spirit and the principles of the invention.

In the foregoing specification, the invention has been described with reference to specific examples of embodiments of the invention. It will, however, be evident that various modifications and changes may be made therein without departing from the broader spirit and scope of the invention as set forth in the appended claims.

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

Because the illustrated embodiments of the present invention may for the most part, be implemented using electronic components and circuits known to those skilled in the art, details will not be explained in any greater extent than that considered necessary as illustrated above, for the understanding and appreciation of the underlying concepts of the present invention and in order not to obfuscate or distract from the teachings of the present invention.

Any reference in the specification to a method should be applied mutatis mutandis to a system capable of executing the method and should be applied mutatis mutandis to a non-transitory computer readable medium that stores instructions that once executed by a computer result in the execution of the method.

Any reference in the specification to a system should be applied mutatis mutandis to a method that may be executed by the system and should be applied mutatis mutandis to a non-transitory computer readable medium that stores instructions that may be executed by the system.

Any reference in the specification to a non-transitory computer readable medium should be applied mutatis mutandis to a system capable of executing the instructions stored in the non-transitory computer readable medium and should be applied mutatis mutandis to method that may be executed by a computer that reads the instructions stored in the non-transitory computer readable medium.

Any reference to “having”, “including” or “comprising” should be applied mutatis mutandis to “consisting” and/or “consisting essentially of”.

What is claimed is:

1. A distributed network for patent asset ownership verification and aggregation of said asset availability into an asset pool, the network configured to execute transactions between special purpose asset pool accounts and a platform for listing assets, said network comprising:
at least one hardware processor, a non-transitory machine-readable storage medium having an executable computer readable program code, the at least one hardware processor;
said hardware processor configured to communicate between at least two nodes, each node capable of communication with at least one other node;
said hardware processor configured to execute the computer-readable program code, the code configured to:
autonomously determine a risk criteria and secondary asset search parameters based on a first asset portfolio;
autonomously communicate with and search a database of asset listings and identify assets that substantially match the secondary asset search parameters;
receive by the distributed network a request to validate a smart contract that determines at least one rule associated with a purchase of the secondary asset;
execute said smart contract and record ownership information related to the secondary asset, wherein transparent asset pricing based on entity size and asset and revenue profile for providing democratized asset availability for the public; and
a blockchain program enabling external users to access data external to said hardware processor satisfying said secondary search parameters, and wherein said blockchain is publicly available for storing, securing and tracing asset data related to said asset and wherein a secure cryptographic access is provided pertaining to said assets.
